(19) United States
(12) Patent Application Publication
(10) Pub. No.: US 2024/0243985 A1
(43) Pub. Date: Jul. 18, 2024

(54) FALLBACK CONDITION FROM TRP-SPECIFIC BFR TO CELL-SPECIFIC BFR

(71) Applicant: QUALCOMM Incorporated, San Diego, CA (US)

(72) Inventors: Fang YUAN, Beijing (CN); Yan ZHOU, San Diego, CA (US); Ruiming ZHENG, Beijing (CN); Linhai HE, San Diego, CA (US); Tao LUO, San Diego, CA (US)

(21) Appl. No.: 18/562,265

(22) PCT Filed: Jul. 28, 2021
(86) PCT No.: PCT/CN2021/108905

§ 371 Date: Nov. 17, 2023

(51) Int. Cl. H04L 43/0811; H04W 72/1268; H04W 74/0833

(52) U.S. Cl. CPC H04L 43/0811; H04W 72/1268; H04W 74/0833

(57) ABSTRACT

A configuration for fallback condition from TRP-specific BFR to cell-specific BFR. The apparatus receives a configuration for a cell-specific BFR procedure and a TRP-specific BFR procedure. The apparatus detects a first beam failure at a first TRP of a cell. The apparatus detects a second beam failure at a second TRP of the cell. The apparatus initiates the cell-specific BFR procedure based at least on the first beam failure at the first TRP or the second beam failure at the second BFR.

### TECHNICAL FIELD

The present disclosure relates generally to communication systems, and more particularly, to wireless communication including a configuration for a beam failure report (BFR).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus receives a configuration for a cell-specific beam failure report (BFR) procedure and a transmission reception point (TRP)-specific BFR procedure. The apparatus detects a first beam failure at a first TRP of a cell. The apparatus detects a second beam failure at a second TRP of the cell. The apparatus initiates the cell-specific BFR procedure, instead of a TRP-specific procedure, based at least on the first beam failure at the first TRP or the second beam failure at the second BFR.

In an aspect of the disclosure, a method, a computer-readable medium, and an apparatus are provided. The apparatus may be a device at a base station. The device may be a processor and/or a modem at a base station or the base station itself. The apparatus transmits, to a user equipment (UE), a configuration for a cell-specific beam failure report (BFR) procedure and a transmission reception point (TRP)-specific BFR procedure. The apparatus receives, from the UE, a scheduling request to initiate a TRP-specific BFR procedure for at least a first beam failure at a first TRP of a cell. The apparatus receives, from the UE, a request to initiate a cell-specific BFR based at least on the first beam failure at the first TRP or a second beam failure at a second BFR of the cell. The apparatus transmits, to the UE, a BFR confirmation to initiate the cell-specific BFR.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A and 4B are diagrams illustrating examples of BFR.

FIG. 5 is a call flow diagram of signaling between a UE and a base station.

FIG. 6 is a flowchart of a method of wireless communication.

FIG. 7 is a flowchart of a method of wireless communication.

FIG. 8 is a diagram illustrating an example of a hardware implementation for an example apparatus.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a diagram of a BFR signal.

### DETAILED DESCRIPTION

A UE may communicate with one or more TRPs associated with a cell of a base station. The UE may be configured with a TRP-specific BFR for a cell. The UE may be configured with different triggering and report procedures for different TRPs. Thus, the UE may separately determine and report a beam failure for a particular TRP. TRP specific BFR may occur asynchronously, and when a beam fails for one TRP, the other TRP may have a beam that is about to fail, is in failure, or that is continuing to experience good conditions. Aspects presented herein provide for a UE to change from providing TRP-specific BFR to providing a cell-specific BFR based on particular conditions such as a beam failure for multiple TRPs based on a TRP-specific BFR configuration. The change to a cell specific BFR may enable the UE to provide the base station with beam failure information in a more efficient manner and may enable the base station to quickly address the beam failure.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

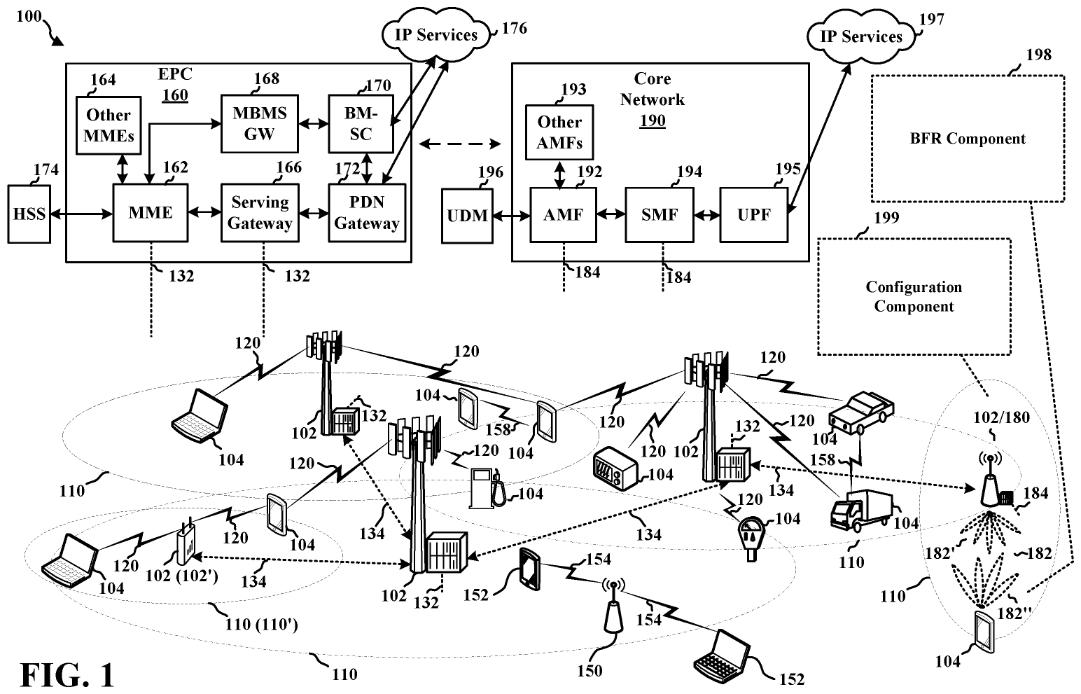

A UE (e.g., such as UE 104 in FIG. 1) may communicate with one or more TRPs associated with a cell of a base station. The UE may be configured with BFR procedures. For example, the UE may be configured with cell-specific BFR in a Pcell. The UE may also be configured with TRP-specific BFR in the Pcell. In some instances, the UE may be configured to support simultaneous configuration of cell-specific BFR (e.g., RACH based BFR procedure) and TRP-specific BFR on at least a special cell (SpCell).

In instances of two or more TRP-specific BFR, each BFR procedure may have independent triggering and/or reporting procedures. In some instances, two TRP-specific BFRs may occur asynchronously. For example, when a beam failure is detected in a first TRP, the beam for the second TRP may be about to fail, in failure, or not in failure. In view of the possibility of separate operation of two TRP-specific BFRs, a need exists for clarification of conditions that may trigger the cell-specific BFR instead of separate TRP-specific BFR.

A UE may be configured to initiate a cell-specific BFR if multiple beam failures are detected by the UE for multiple TRPs on the same cell or CC. The configuration may allow the UE to switch to a cell-specific BFR instead of the TRP-specific BFR, which may assist in improving reliability and latency in wireless communication systems.

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHZ). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to initiate a cell-specific BFR procedure upon detection of beam failures at multiple TRPs. For example, the UE 104 may comprise a BFR component 198 configured to initiate a cell-specific BFR procedure upon detection of beam failures at multiple TRPs. The UE 104 may receive a configuration for a cell-specific BFR procedure and a TRP-specific BFR procedure. The UE 104 may detect a first beam failure at a first TRP of a cell. The UE 104 may detect a second beam failure at a second TRP of the cell. The UE 104 may initiate the cell-specific BFR procedure, instead of a TRP-specific procedure, based at least on the first beam failure at the first TRP or the second beam failure at the second BFR.

Referring again to FIG. 1, in certain aspects, the base station 180 may be configured to configure a UE to initiate a cell-specific BFR procedure upon detection of beam failures at multiple TRPs. For example, the base station 180 may comprise a configuration component 199 configured to configure a UE to initiate a cell-specific BFR procedure upon detection of beam failures at multiple TRPs. The base station 180 may transmit, to a UE 104, a configuration for a cell-specific BFR procedure and a TRP-specific BFR procedure. The base station 180 may receive, from the UE 104, a scheduling request to initiate a TRP-specific BFR procedure for at least a first beam failure at a first TRP of a cell. The base station 180 may receive, from the UE 104, a request to initiate a cell-specific BFR based at least on the first beam failure at the first TRP or a second beam failure at a second BFR of the cell. The base station may transmit, to the UE, a BFR confirmation to initiate the cell-specific BFR.

Although the following description may be focused on 5G NR, the concepts described herein may be applicable to other similar areas, such as LTE, LTE-A, CDMA, GSM, and other wireless technologies.

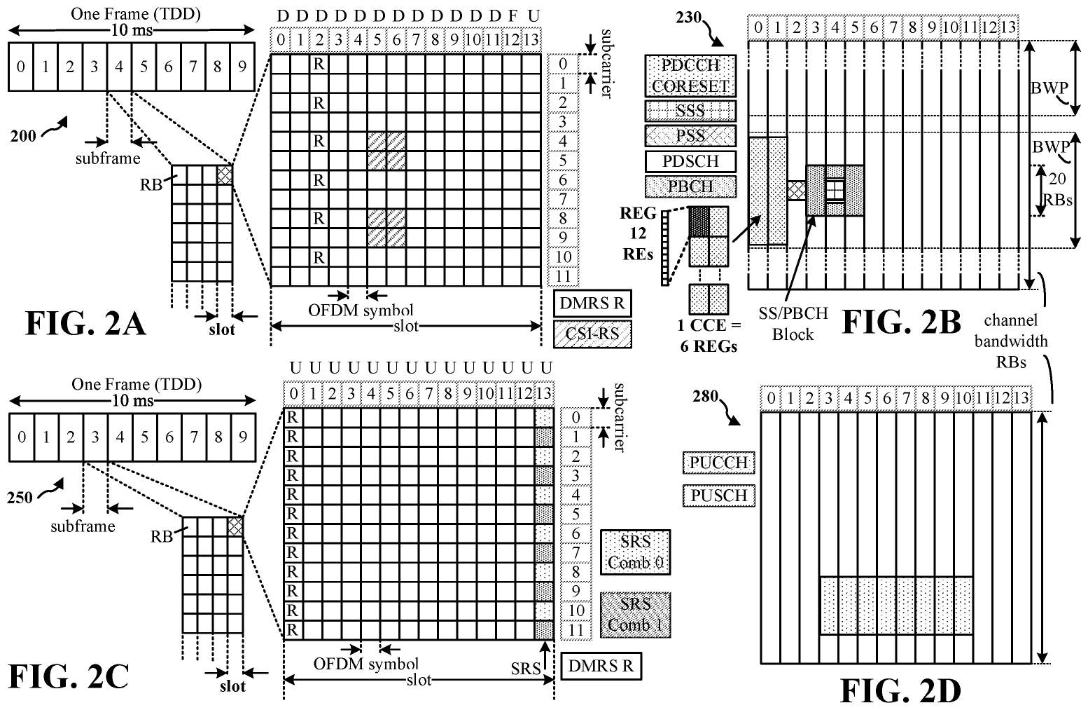

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

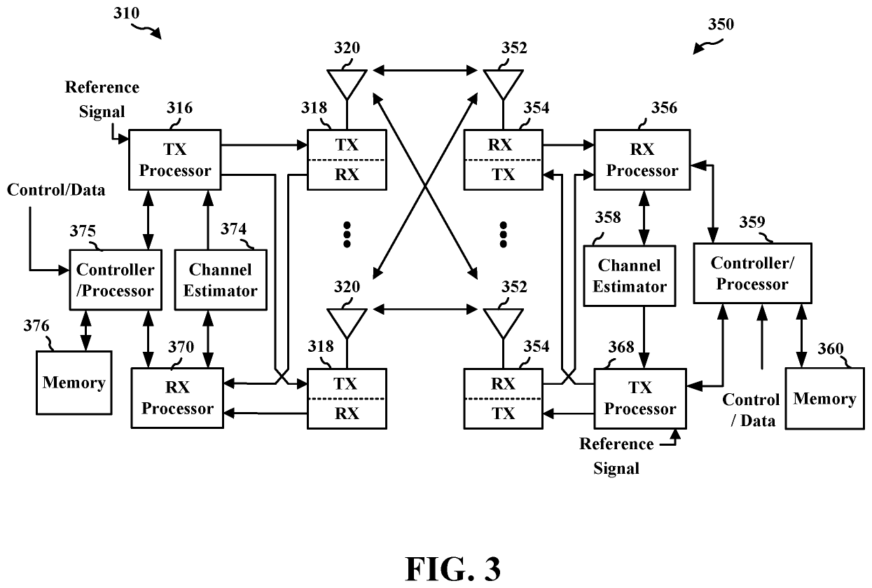

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

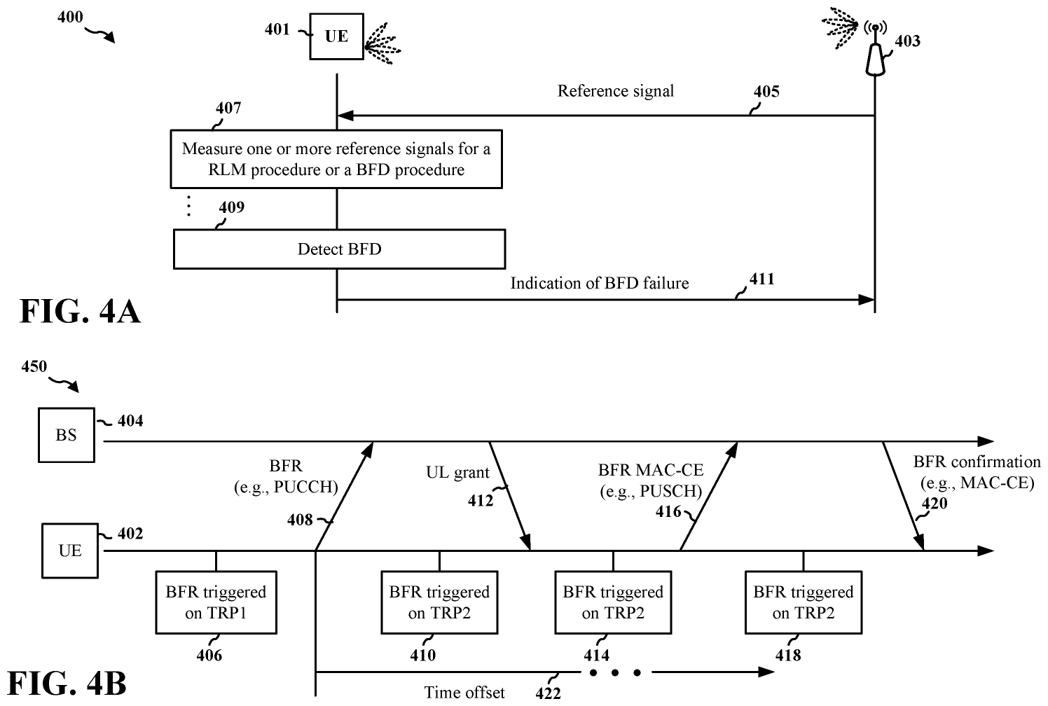

A UE (such as UE 104 in FIG. 1 or UE 350 in FIG. 3) may monitor the quality of the beams that the UE uses for communication with a base station. For example, a UE may monitor a quality of a signal received via reception beam(s). A Beam Failure Detection (BFD) procedure may be used to identify problems in beam quality and a Beam recovery procedure including beam failure recovery (BFR) may be used when a beam failure is detected. FIG. 4A illustrates an example of a BFD procedure 400. For monitoring active link performance, a UE 401 may perform measurements 407 of at least one signal, e.g., reference signals 405, from a base station 403 for beam failure detection. The reference signal may comprise any of CSI-RS. Physical Broadcast Channel (PBCH), a synchronization signal, an SSB, or other reference signals for time and/or frequency tracking, etc. The UE may receive an indication of reference signal resources to be used to measure beam quality in connection with BFD. The measurements 407 may include deriving a metric similar to a Signal to Interference plus Noise Ratio (SINR) for the signal, or RSRP strength or block error rate (BLER) of a reference control channel chosen by base station and/or implicitly derived by UE based on the existing RRC configuration. The measurement(s) may indicate the UE's ability to transmit an uplink transmission to the base station using the beam.

The UE 401 may compare the measurement of the reference signal, at 407, to a threshold to determine the radio link conditions, the threshold(s) may correspond to an RSRP value, a BLER value, etc. that indicates an in-sync condition and/or an out-of-sync condition of the radio link. An “out-of-sync” condition may indicate that the radio link condition is poor, and an “in-sync” condition may indicate that the radio link condition is acceptable, and the base station is likely to receive a transmission transmitted on the radio link. An Out-of-Sync condition may be declared when a block error rate for the radio link falls below a threshold over a specified time interval. An in-sync condition may be declared when a block error rate for the radio link is better than a threshold over a specified time interval. If the UE receives a threshold number of consecutive out-of-sync measurements over a period of time, the UE may declare a beam failure. Thus, after multiple instances of the measurement of the reference signal for a beam not meeting the threshold to be considered in-sync, the UE 401 may consider a beam failure to be detected, at 409.

When a beam failure is detected, the UE 401 may take appropriate actions to recover the connection. For example, after multiple out-of-sync measurements, the UE 401 may transmit a beam failure recovery signal, at 411, to initiate recovery of the connection with the base station 403. For example, the UE 401 may receive a configuration, e.g., in RRC signaling, with a beam failure recovery procedure that is used to indicate to the base station that the beam failure has been detected. The UE 401 may send the indication to the base station 403 based on the configuration. The base station 403 and the UE 401 may switch to a new beam as part of the beam failure recovery procedure. The base station 403 and UE 401 may communicate over active data/control beams both for DL communication and UL communication.

A UE may communicate with one or more TRPs associated with a cell of a base station. As described in connection with FIG. 4A, the UE may be configured with BFR procedures. For example, the UE may be configured with cell-specific BFR for a Pcell. The UE may also be configured with TRP-specific BFR for a cell such as the Pcell. For example, the UE may be configured to support two TRP-specific BFRs in the Pcell. The UE may be configured to support the TRP-specific BFR and the cell-specific BFR. In some instances, the UE may be configured to support simultaneous configuration of cell-specific BFR (e.g., RACH based) and TRP-specific BFR on at least a special cell (SpCell). Simultaneous configuration may refer to the configuration of contention based random access (CBRA) based BFR and TRP-specific BFR on the same component carrier (CC). In instances of beam failure on two TRPs for TRP-specific BFR on SpCell, CBRA RACH based BFR may be utilized. For example, if two sets of beam failure detection reference signals for TRP-specific BFR are configured on the SpCell, there may not be any additional configured beam failure detection reference signals for cell-specific RACH based BFR on the SpCell. The RACH based BFR may refer to contention free random access (CFRA) based cell-specific BFR and/or CBRA based cell-specific BFR on SpCell.

In instances of two or more TRP-specific BFR, each BFR procedure may have independent triggering and/or reporting procedures. The TRP-specific beam failure detection for each TRP may be conducted in the MAC layer separately based on the separate beam failure instance reporting from the PHY layer. The periodicity of beam failure instance reporting of each TRP may be different. In some instances, two TRP-specific BFRs may occur asynchronously. For example, when a beam failure is detected in a first TRP, the beam for the second TRP may be about to fail, in failure, or not in failure. In view of the possibility of separate operation of two TRP-specific BFRs, aspects presented herein provide conditions that may trigger the UE to send a cell-specific BFR instead of separate TRP-specific BFR.

Aspects presented herein provide a configuration for fallback condition from TRP-specific BFR to cell-specific BFR. As an example, the UE may be configured to initiate a cell-specific BFR, instead of TRP-specific BFR, if multiple beam failures are detected by the UE for multiple TRPs on the same cell or CC. The initiation of the cell-specific BFR may occur at different instances before or after the initiation of the TRP-specific BFR. The configuration may allow the UE to switch to a cell-specific BFR instead of the TRP-specific BFR.

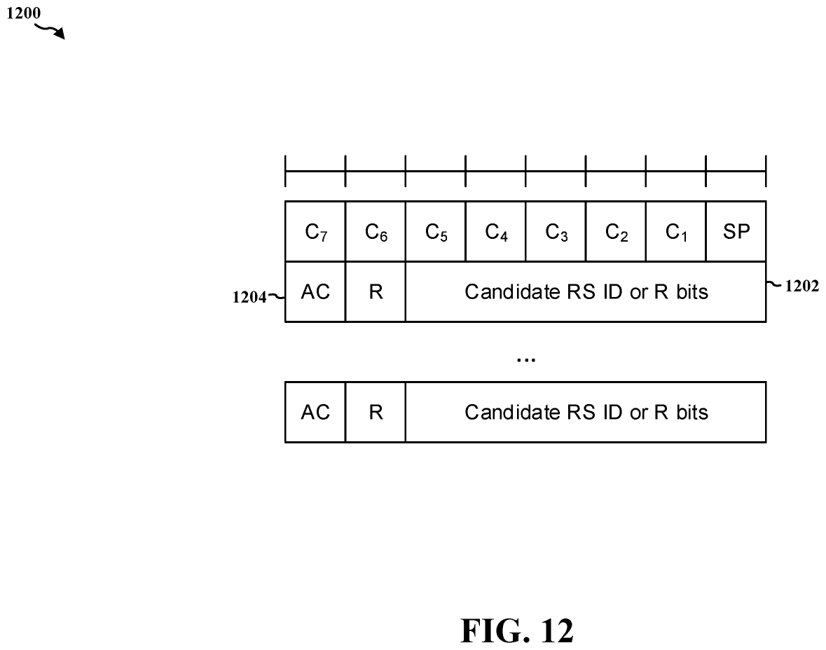

In some aspects, the UE may be simultaneously configured for cell-specific BFR and two or more TRP-specific BFRs in a cell. The UE may initiate the cell-specific BFR, instead of the two or more TRP-specific BFRs, if the UE determines to report (e.g., multiplex) two TRP-specific BFR information for the same cell or CC in a single MAC-CE, along with certain conditions. For example, the cell-specific BFR may be initiated if the two or more TRP-specific BFRs do not have new beam information for the same CC. For example, with reference to FIG. 12, the UE may transmit the BFR MAC-CE 1200 to the base station. In the MAC-CE 1200, the UE may report candidate reference signals (RS) identifier (ID) 1202 which may include information identifying a new beam for the beam recovery. However, in some instances, the UE may not be able to find a new beam upon detection of failure of the current beam. In such instances, the UE may set a value of an AC bit 1204 to 0 (zero) indicating that a new beam information is not reported, e.g., there is no candidate beam for beam recovery. In such instances, the UE may transmit a contention-based PRACH to initiate the cell-specific BFR. In another example, if one of the TRP-specific BFRs do not have new beam information for the same CC, in such instances, the UE may transmit a contention-free based PRACH to initiate the cell-specific BFR. In some instances, the cell-specific BFR may be initiated prior to transmission of any scheduling request, by the UE, to initiate a TRP-specific BFR. In some instances, the cell-specific BFR may be initiated after transmission of a scheduling request to initiate a TRP-specific BFR, and the UE is able to multiplex two TRP-specific BFRs for the same CC or cell in a single MAC-CE.

FIG. 4B is a diagram 450 illustrating conditions for initiating a cell-specific BFR. The diagram 450 includes a UE 402 and a base station 404. The UE 402 may communicate with first TRP (e.g., TRP1) and a second TRP (e.g., TRP2) that are associated with a cell of the base station 404. The TRP may be used for illustrative purposes, where different TRPs may have different BFR configurations or different BFR resources. The UE may be configured with a cell-specific BFR and a multiple TRP-specific BFR in a cell. The UE may initiate the cell-specific BFR if the UE has initiated a first TRP-specific BFR in a cell, and the UE determines to initiate a second TRP-specific BFR for the same cell. The cell-specific BFR may be initiated based on a time occasion of the first TRP-specific BFR procedure.

In some aspects, the occurrence of an event at the UE 402, at 406, may trigger or initiate the TRP-specific BFR for TRP1. The event may include one or more instances of measurements or beam failure detections indicating a beam failure. The UE may transmit a request or report (e.g., PUCCH) 408 to the base station 404 to initiate the BFR or to otherwise indicate the beam failure to the base station 404. The transmission of the request 408 to initiate the TRP-specific BFR for TRP1 may start the initiation procedure. In some aspects, for example at 410, the UE 402 may detect a beam failure at a second TRP (e.g., TRP2) and may determine to initiate a second TRP-specific BFR for TRP2. In such instances, as the UE 402 has not yet received an uplink grant 412 that schedules the transmission of a BFR MAC-CE (e.g., in a PUSCH) 416 for the TRP-specific BFR for TRP1, the UE 402 may initiate the cell-specific BFR for TRP1 and TRP2.

In some aspects, the UE 402, at 406, may trigger or initiate the TRP-specific BFR for TRP1, and the UE transmits the request (e.g., PUCCH) 408 to initiate the BFR to the base station 404. The UE 402 may receive the uplink grant 412 that schedules the transmission of the BFR MAC-CE (e.g., PUSCH) 416 for the TRP-specific BFR for TRP1. After reception of the uplink grant 412, the UE 402 may detect a beam failure at the second TRP (e.g., TRP2) and may determine, at 414, to initiate a second TRP-specific BFR for TRP2. In some instances, as the UE 402 has not yet transmitted the BFR MAC-CE 416 in response to receipt of the uplink grant 412, the UE 402 may initiate the cell-specific BFR for TRP1 and TRP2. In some instances, the UE 402 may have received the uplink grant for the TRP-specific BFR for TRP1 and may have determined to initiate the second TRP-specific BFR for TRP2, the UE may multiplex the TRP-specific BFR for TRP2 with the TRP-specific BFR for TRP1 for transmission in the BFR MAC-CE 416. In such instances, the UE 402 may initiate the cell-specific BFR, if the UE has not yet multiplexed the TRP-specific BFR for TRP2 with the TRP-specific BFR for TRP1 in the BFR MAC-CE 416.

In some aspects, the UE 402, at 406, may trigger or initiate the TRP-specific BFR for TRP1, and transmit the request (e.g., scheduling request PUCCH) 408 to initiate the BFR to the base station 404. The UE 402 may receive the uplink grant 412 and transmit the BFR MAC-CE 416 which only includes the TRP-specific BFR for TRP1. In some aspects, after transmission of the BFR MAC-CE 416 for the TRP-specific BFR for TRP1, the UE, at 418, may determine to initiate a second TRP-specific BFR for TRP2. In such instances, the UE may initiate the cell-specific BFR prior to the receipt of a BFR confirmation (e.g., MAC-CE) 420 from the base station 404 for the TRP-specific BFR for TRP1. In some aspects, the BFR confirmation may comprise an uplink DCI scheduling with a same HARQ identifier and new data indicator (NDI) toggled as the PUSCH with a MAC-CE BFR for the TRP-specific BFR for TRP1.

In some aspects, the UE 402 may initiate the cell-specific BFR prior to a time offset 422 from the transmission of the request (e.g., PUCCH) 408 to initiate the TRP-specific BFR for TRP1 to the base station 404.

In some aspects, if the UE initiates the cell-specific BFR, the UE may terminate the TRP-specific BFR procedure. For example, the UE may transmit, to the base station, an indication cancelling any pending scheduling request transmitted for the TRP-specific BFR for the TRP1 or the TRP-specific BFR for the TRP2. In some aspects, the UE may stop a respective timer (e.g., sr-ProhibitTimer) corresponding to the TRP-specific BFR for the TRP1 or the TRP-specific BFR for the TRP2.

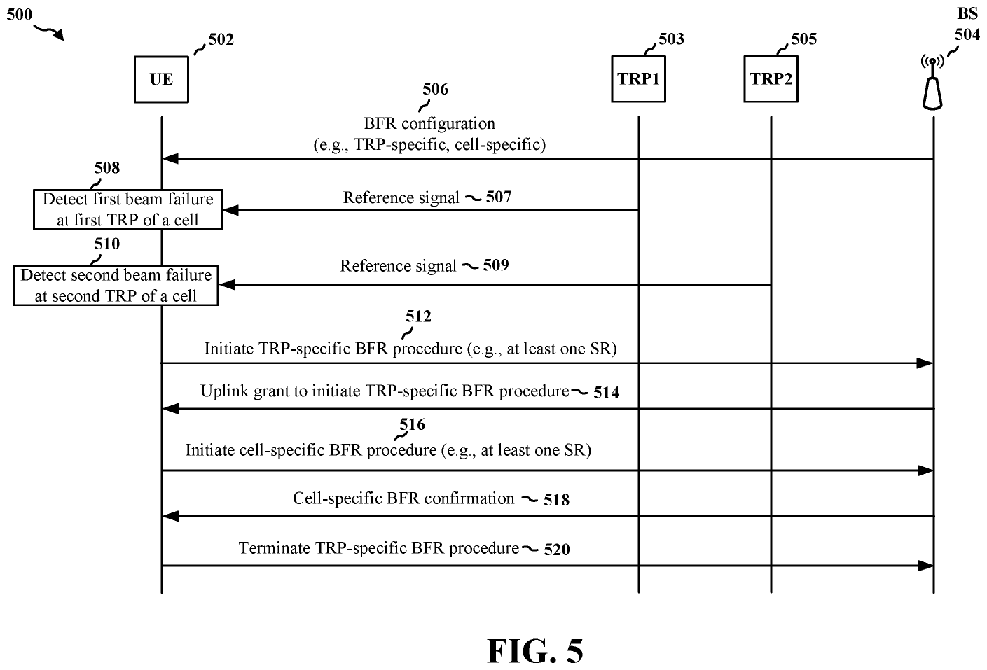

FIG. 5 is a call flow diagram 500 of signaling between a UE 502 and a base station 504. The base station 504 may be configured to provide at least one cell. The UE 502 may be configured to communicate with the base station 504 via multiple TRPs of the base station 504. Although FIG. 5 illustrates an example showing two TRPs, the aspects presented herein are similarly applicable to more than two TRPs. For example, in the context of FIG. 1, the base station 504 may correspond to base station 102/180 and, accordingly, the cell may include a geographic coverage area 110 in which communication coverage is provided and/or small cell 102′ having a coverage area 110′. Further, a UE 502 may correspond to at least UE 104. In another example, in the context of FIG. 3, the base station 504 may correspond to base station 310 and the UE 502 may correspond to UE 350.

As illustrated at 506, the base station 504 may transmit a configuration for BFR procedures. The configuration may be transmitted from the base station 504 to the UE 502 via one or more of the TRP1 503 or the TRP2 505. The configuration for the BFR procedures may comprise a configuration for a cell-specific BFR procedure and a TRP-specific BFR procedure. The base station may transmit the configuration for the BFR procedures to the UE 502. The UE 502 may receive the BFR configuration from the base station 504.

As illustrated at 508, the UE 502 may detect a first beam failure. The UE may detect the first beam failure at a first TRP 503 of a cell. The first TRP 503 may be associated with the base station 504. For example, the first TRP 503 may send one or more reference signals 507 for beam failure detections to the UE 502. The UE 502 may measure the one or more reference signals 507 and detect the first beam failure at the first TRP 503 if measurement of the reference signals 507 falls below a threshold value. The reference signal may comprise any of a CSI-RS, a PBCH, a synchronization signal, an SSB, or other reference signals for time and/or frequency tracking, etc.

As illustrated at 510, the UE 502 may detect a second beam failure. The UE may detect the second beam failure at a second TRP 505 of the cell. The second TRP 505 may be associated with the base station 504. For example, the second TRP 505 may send one or more reference signals 509 for beam failure detections to the UE 502. The UE 502 may measure the one or more reference signals 509 and detect the second beam failure at the second TRP 505 if measurement of the reference signals 509 falls below a threshold. The threshold for detection of the first beam failure at the first TRP 503 or the second beam failure at the second TRP 505 may be the same or different. The first TRP 503 and the second TRP 505 may be associated with the same cell of the base station 504.

As illustrated at 512, the UE 502 may transmit at least one SR. The UE may transmit the at least one SR for at least one of the first TRP BFR or the second TRP BFR. The UE may transmit the at least one SR to the base station 504. The base station 504 may receive the at least one SR from the UE 502. The UE may transmit the at least one SR to initiate the TRP-specific BFR procedure for at least one of the first beam failure at the first TRP or the second beam failure at the second TRP.

As illustrated at 514, the base station 504 may transmit an uplink grant. The base station may transmit the uplink grant to initiate the TRP-specific BFR procedure. The base station may transmit the uplink grant to the UE 502. The UE 502 may receive the uplink grant from the base station 504. The base station may transmit the uplink grant to initiate the TRP-specific BFR procedure in response to the at least one SR to initiate the TRP-specific BFR procedure for at least the first beam failure at the first TRP or the second beam failure at the second TRP.

As illustrated at 516, the UE 502 may initiate the cell-specific BFR procedure. The UE may initiate the cell-specific BFR procedure instead of a TRP-specific procedure. The UE may initiate the cell-specific BFR procedure instead of the TRP-specific procedure based at least on the first beam failure at the first TRP or the second beam failure at the second BFR. In some aspects, the UE may initiate the cell-specific BFR procedure instead of the TRP-specific procedure based at least on the first beam failure at the first TRP and the second beam failure at the second BFR. The UE detecting multiple beam failures at different TRPs associated with the same cell may allow for the UE to multiplex the two TRP-specific BFRs for the same cell in a single MAC-CE in order to trigger the cell-specific BFR procedure instead of the TRP-specific BFR procedure.

In some aspects, the UE 502 may transmit a contention-based physical random access channel (PRACH) to initiate the cell-specific BFR procedure. In some aspects, the cell-specific BFR procedure may be initiated, by transmission of the contention-based PRACH, if the first TRP BFR and the second TRP BFR lack new beam information for a same component carrier of the cell. For example, the first TRP BFR and the second TRP BFR may lack new beam information in instances where the first TRP BFR and the second TRP BFR have not received a beam failure recovery response.

In some aspects, the UE 502 may transmit a contention-free PRACH to initiate the cell-specific BFR procedure. In some aspects, the cell-specific BFR procedure may be initiated, by transmission of the contention-free PRACH, if one of the first TRP BFR or the second TRP BFR lack new beam information for a same component carrier of the cell.

The UE may initiate the cell-specific BFR procedure instead of a TRP-specific procedure. The UE may initiate the cell-specific BFR procedure instead of the TRP-specific procedure based at least on the first beam failure at the first TRP or the second beam failure at the second BFR. In some aspects, the cell-specific BFR procedure may be initiated prior to receipt of an uplink grant scheduling a transmission of the first TRP BFR. In some aspects, the cell-specific BFR procedure may be initiated prior to transmission of the first TRP BFR. In some aspects, the cell-specific BFR procedure may be initiated prior to a multiplexing of the second TRP BFR with the first TRP BFR. In some aspects, the cell-specific BFR procedure may be initiated prior to reception of a BFR confirmation from a base station. In some aspects, the cell-specific BFR procedure may be initiated based on a time offset from transmission of a scheduling request for the first TRP BFR.

As illustrated at 518, the base station 504 may transmit a BFR confirmation to initiate the cell-specific BFR. The base station may transmit the BFR communication to initiate the cell-specific BFR to the UE 502. The UE 502 may receive the BFR confirmation to initiate the cell-specific BFR from the base station 504.

As illustrated at 520, the UE 502 may terminate the TRP-specific BFR procedure. In some aspects, to terminate the TRP-specific BFR procedure, the UE may cancel any pending scheduling request transmitted for the first TRP BFR or the second TRP BFR. The UE 502 may transmit an indication to cancel any pending scheduling request for the first TRP BFR or the second TRP BFR to the base station 504. The base station 504 may receive the indication to cancel any pending scheduling request for the first TRP BFR or the second TRP BFR from the UE 502. In some aspects, to terminate the TRP-specific BFR procedure, the UE may stop a respective time corresponding to the first TRP BFR or the second TRP BFR.

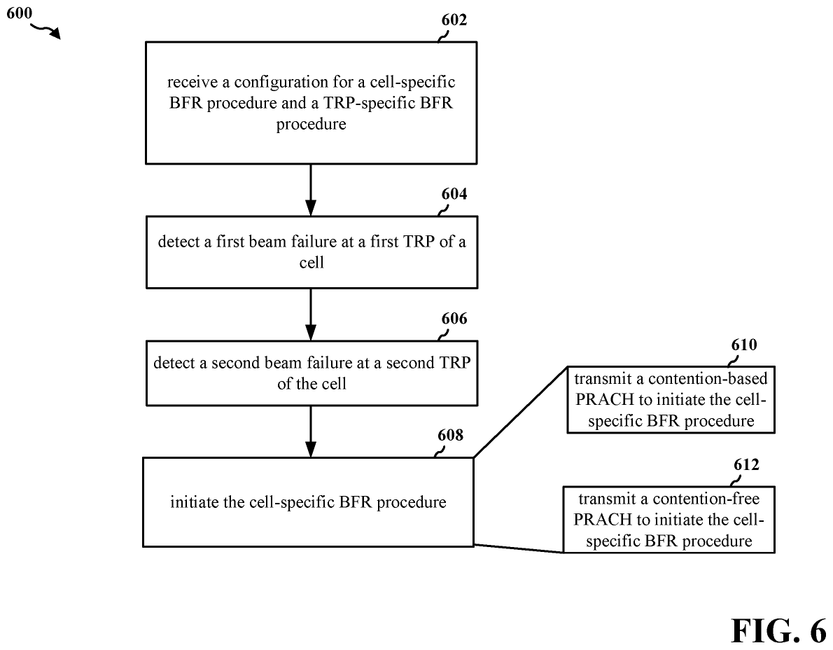

FIG. 6 is a flowchart 600 of a method of wireless communication. The method may be performed by a UE or a component of a UE (e.g., the UE 104; the apparatus_1002; the cellular baseband processor_1004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to initiate a cell-specific BFR procedure upon detection of beam failures at multiple TRPs.

At 602, the UE may receive a configuration for BFR procedures. For example, 602 may be performed by configuration component 840 of apparatus 802. The configuration for the BFR procedures may comprise a cell-specific BFR procedure and a TRP-specific BFR procedure. The UE may receive the configuration for BFR procedures from a base station.

At 604, the UE may detect a first beam failure. For example, 604 may be performed by detection component 842 of apparatus 802. The UE may detect the first beam failure at a first TRP of a cell.

At 606, the UE may detect a second beam failure. For example, 606 may be performed by detection component 842 of apparatus 802. The UE may detect the second beam failure at a second TRP of the cell.

At 608, the UE may initiate the cell-specific BFR procedure. For example, at 610, the UE may transmit a contention-based PRACH to initiate the cell-specific BFR procedure. For example, 610 may be performed by BFR component 846 of apparatus 802. In some aspects, the cell-specific BFR procedure may be initiated, by transmission of the contention-based PRACH, if the first TRP BFR and the second TRP BFR lack new beam information for a same component carrier of the cell. For example, the first TRP BFR and the second TRP BFR may lack new beam information in instances where the first TRP BFR and the second TRP BFR have not received a beam failure recovery response.

As another example, at 612, the UE may transmit a contention-free PRACH to initiate the cell-specific BFR procedure. For example, 612 may be performed by BFR component 846 of apparatus 802. In some aspects, the cell-specific BFR procedure may be initiated, by transmission of the contention-free PRACH, if one of the first TRP BFR or the second TRP BFR lack new beam information for a same component carrier of the cell.

The UE may initiate the cell-specific BFR procedure instead of a TRP-specific procedure. The UE may initiate the cell-specific BFR procedure instead of the TRP-specific procedure based at least on the first beam failure at the first TRP or the second beam failure at the second BFR. In some aspects, the cell-specific BFR procedure may be initiated prior to receipt of an uplink grant scheduling a transmission of the first TRP BFR. In some aspects, the cell-specific BFR procedure may be initiated prior to transmission of the first TRP BFR. In some aspects, the cell-specific BFR procedure may be initiated prior to a multiplexing of the second TRP BFR with the first TRP BFR. In some aspects, the cell-specific BFR procedure may be initiated prior to reception of a BFR confirmation from a base station. In some aspects, the cell-specific BFR procedure may be initiated based on a time offset from transmission of a scheduling request for the first TRP BFR.

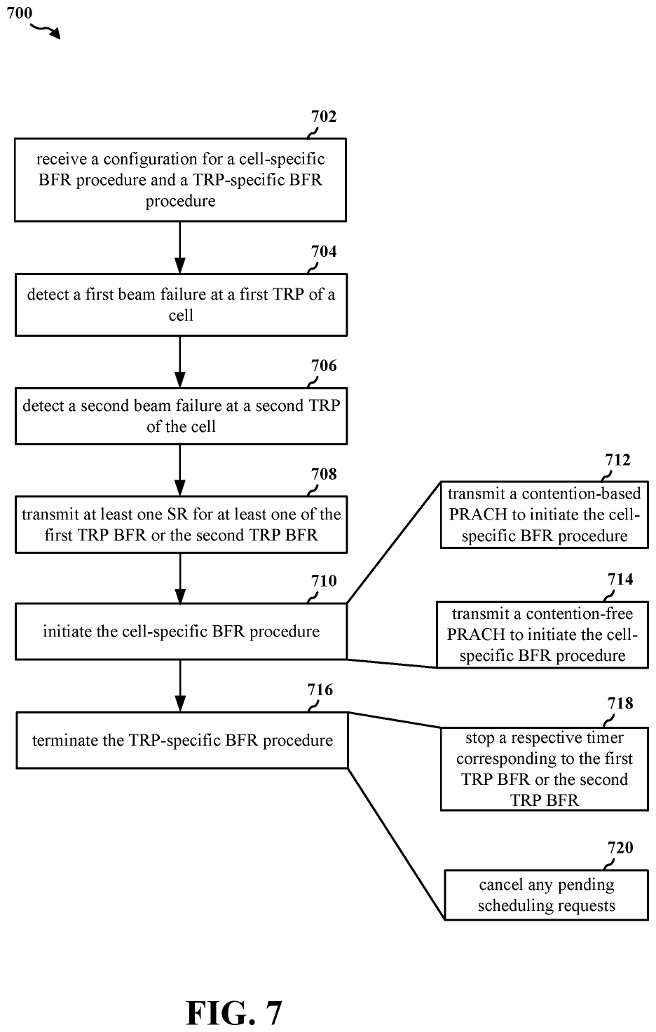

FIG. 7 is a flowchart 700 of a method of wireless communication. The method may be performed by a UE or a component of a UE (e.g., the UE 104; the apparatus 802; the cellular baseband processor 804, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to initiate a cell-specific BFR procedure upon detection of beam failures at multiple TRPs.

At 702, the UE may receive a configuration for BFR procedures. For example, 702 may be performed by configuration component 840 of apparatus 802. The configuration for the BFR procedures may comprise a cell-specific BFR procedure and a TRP-specific BFR procedure. The UE may receive the configuration for BFR procedures from a base station.

At 704, the UE may detect a first beam failure. For example, 604 may be performed by detection component 842 of apparatus 802. The UE may detect the first beam failure at a first TRP of a cell.

At 706, the UE may detect a second beam failure. For example, 606 may be performed by detection component 842 of apparatus 802. The UE may detect the second beam failure at a second TRP of the cell.

At 708, the UE may transmit at least one SR. For example, 708 may be performed by SR component 844 of apparatus 802. The UE may transmit the at least one SR for at least one of the first TRP BFR or the second TRP BFR. The UE may transmit the at least one SR to initiate the TRP-specific BFR procedure for at least one of the first beam failure at the first TRP or the second beam failure at the second TRP.

At 710, the UE may initiate the cell-specific BFR procedure. For example, at 712, the UE may transmit a contention-based PRACH to initiate the cell-specific BFR procedure. For example, 712 may be performed by BFR component 846 of apparatus 802. In some aspects, the cell-specific BFR procedure may be initiated, by transmission of the contention-based PRACH, if the first TRP BFR and the second TRP BFR lack new beam information for a same component carrier of the cell. For example, the first TRP BFR and the second TRP BFR may lack new beam information in instances where the first TRP BFR and the second TRP BFR have not received a beam failure recovery response.

As another example, at 714, the UE may transmit a contention-free PRACH to initiate the cell-specific BFR procedure. For example, 714 may be performed by BFR component 846 of apparatus 802. In some aspects, the cell-specific BFR procedure may be initiated, by transmission of the contention-free PRACH, if one of the first TRP BFR or the second TRP BFR lack new beam information for a same component carrier of the cell.

The UE may initiate the cell-specific BFR procedure instead of a TRP-specific procedure. The UE may initiate the cell-specific BFR procedure instead of the TRP-specific procedure based at least on the first beam failure at the first TRP or the second beam failure at the second BFR. In some aspects, the cell-specific BFR procedure may be initiated prior to receipt of an uplink grant scheduling a transmission of the first TRP BFR. In some aspects, the cell-specific BFR procedure may be initiated prior to transmission of the first TRP BFR. In some aspects, the cell-specific BFR procedure may be initiated prior to a multiplexing of the second TRP BFR with the first TRP BFR. In some aspects, the cell-specific BFR procedure may be initiated prior to reception of a BFR confirmation from a base station. In some aspects, the cell-specific BFR procedure may be initiated based on a time offset from transmission of a scheduling request for the first TRP BFR.

At 716, the UE may terminate the TRP-specific BFR procedure. For example, at 718, the UE may cancel any pending scheduling request transmitted for the first TRP BFR or the second TRP BFR. For example, 718 may be performed by BFR component 846 of apparatus 802. As another example, at 720, the UE may stop a respective time corresponding to the first TRP BFR or the second TRP BFR. For example, 720 may be performed by BFR component 846 of apparatus 802.

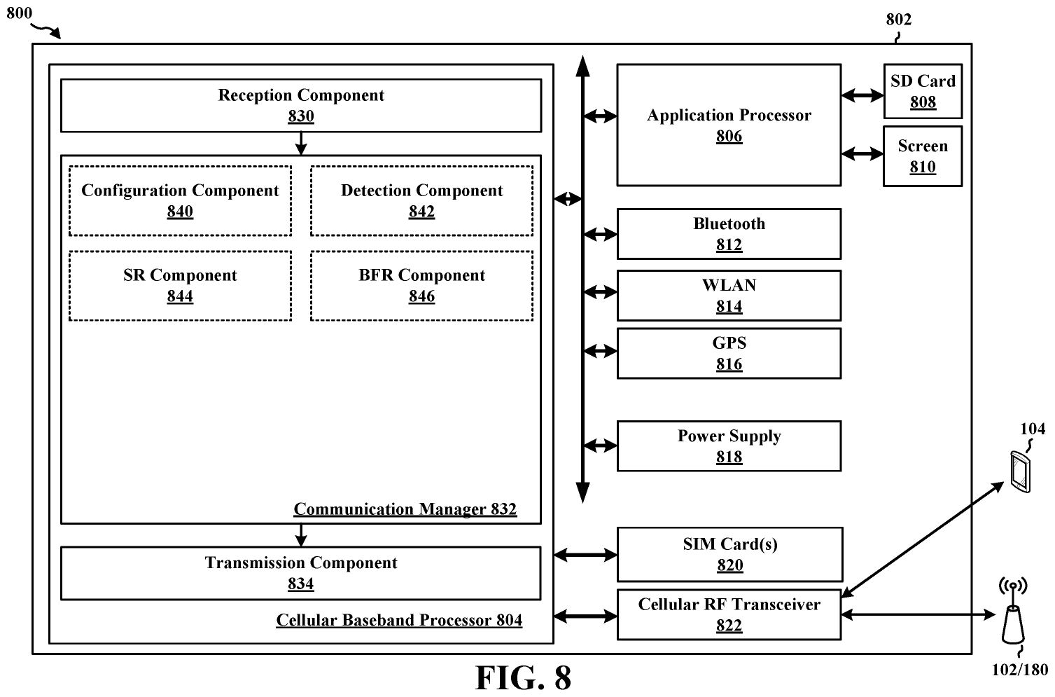

FIG. 8 is a diagram 800 illustrating an example of a hardware implementation for an apparatus 802. The apparatus 802 may be a UE, a component of a UE, or may implement UE functionality. In some aspects, the apparatus 802 may include a cellular baseband processor 804 (also referred to as a modem) coupled to a cellular RF transceiver 822. In some aspects, the apparatus 802 may further include one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, or a power supply 818. The cellular baseband processor 804 communicates through the cellular RF transceiver 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 350 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see 350 of FIG. 3) and include the additional modules of the apparatus 802.

The communication manager 832 includes a configuration component 840 that is configured to receive a configuration for BFR procedures, e.g., as described in connection with 602 of FIG. 6 or 702 of FIG. 7. The communication manager 832 further includes a detection component 842 that is configured to detect a first beam failure, e.g., as described in connection with 604 of FIG. 6 or 704 of FIG. 7. The detection component 842 may be configured to detect a second beam failure, e.g., as described in connection with 606 of FIG. 6 or 706 of FIG. 7. The communication manager 832 further includes an SR component 844 that is configured to transmit at least one SR, e.g., as described in connection with 708 of FIG. 7. The communication manager 832 further includes a BFR component 846 that is configured to transmit a contention-based PRACH to initiate the cell-specific BFR procedure, e.g., as described in connection with 610 of FIG. 6 or 712 of FIG. 7. The BFR component 846 may be configured to transmit a contention-free PRACH to initiate the cell-specific BFR procedure, e.g., as described in connection with 612 of FIG. 6 or 714 of FIG. 7. The BFR component 846 may be configured to cancel any pending scheduling request transmitted for the first TRP BFR or the second TRP BFR, e.g., as described in connection with 718 of FIG. 7. The BFR component 846 may be configured to stop a respective time corresponding to the first TRP BFR or the second TRP BFR. e.g., as described in connection with 720 of FIG. 7.

The apparatus may include additional components that perform each of the blocks of the algorithm in the flowcharts of FIG. 6 or 7. As such, each block in the flowcharts of FIG. 6 or 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 802 may include a variety of components configured for various functions. In one configuration, the apparatus 802, and in particular the cellular baseband processor 804, includes means for receiving a configuration for a cell-specific BFR procedure and a TRP-specific BFR procedure. The apparatus includes means for detecting a first beam failure at a first TRP of a cell. The apparatus includes means for detecting a second beam failure at a second TRP of the cell. The apparatus includes means for initiating the cell-specific BFR procedure, instead of a TRP-specific procedure, based at least on the first beam failure at the first TRP or the second beam failure at the second BFR. The apparatus further includes means for transmitting a contention-based PRACH to initiate the cell-specific BFR procedure. The apparatus further includes means for transmitting a contention-free PRACH to initiate the cell-specific BFR procedure. The apparatus further includes means for transmitting at least one SR for at least one of the first TRP BFR or the second TRP BFR. The apparatus further includes means for terminating the TRP-specific BFR procedure. The apparatus further includes means for cancelling any pending scheduling request transmitted for the first TRP BFR or the second TRP BFR. The apparatus further includes means for stopping a respective timer corresponding to the first TRP BFR or the second TRP BFR. The means may be one or more of the components of the apparatus 802 configured to perform the functions recited by the means. As described supra, the apparatus 802 may include the TX Processor 368, the RX Processor 356, and the controller/processor 359. As such, in one configuration, the means may be the TX Processor 368, the RX Processor 356, and the controller/processor 359 configured to perform the functions recited by the means.

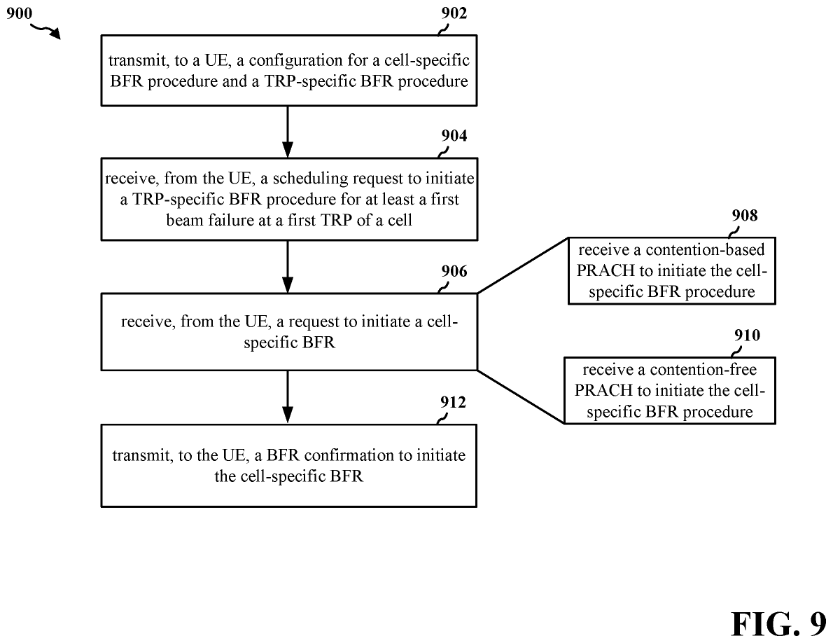

FIG. 9 is a flowchart 900 of a method of wireless communication. The method may be performed by a base station or a component of a base station (e.g., the base station 102/180; the apparatus 1102; the baseband unit 1104, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to configure a UE to initiate a cell-specific BFR procedure upon detection of beam failures at multiple TRPs.

At 902, the base station may transmit a configuration for BFR procedures. For example, 902 may be performed by configuration component 1140 of apparatus 1102. The configuration for the BFR procedures may comprise a configuration for a cell-specific BFR procedure and a TRP-specific BFR procedure. The base station may transmit the configuration for the BFR procedures to a UE.

At 904, the base station may receive a scheduling request to initiate a TRP-specific BFR procedure. For example, 904 may be performed by SR component 1142 of apparatus 1102. The base station may receive the scheduling request to initiate the TRP-specific BFR procedure for at least a first beam failure at a first TRP of a cell. The base station may receive the scheduling request to initiate the TRP-specific BFR procedure from the UE.

At 906, the base station may receive a request to initiate a cell-specific BFR procedure. For example, at 908, the base station may receive a contention-based PRACH to initiate the cell-specific BFR procedure. For example, 908 may be performed by BFR component 1146 of apparatus 1102. In some aspects, the cell-specific BFR procedure may be initiated if the first TRP BFR and the second TRP BFR lack new beam information for a same component carrier of the cell.

As another example, at 910, the base station may receive a contention-free PRACH to initiate the cell-specific BFR procedure. For example, 910 may be performed by BFR component 1146 of apparatus 1102. In some aspects, the cell-specific BFR procedure may be initiated if one of the first TRP BFR or the second TRP BFR lack new beam information for a same component carrier of the cell.

The base station may receive the request to initiate a cell-specific BFR procedure based at least on the first beam failure at the first TRP or a second beam failure at a second BFR of the cell. The base station may receive the request to initiate the cell-specific BFR procedure from the UE. In some aspects, the cell-specific BFR procedure may be initiated prior to transmission of an uplink grant scheduling a transmission of the first TRP BFR. In some aspects, the cell-specific BFR procedure may be initiated prior to reception of the first TRP BFR. In some aspects, the cell-specific BFR procedure may be initiated prior to a multiplexing of the second TRP BFR with the first TRP BFR. In some aspects, the cell-specific BFR procedure may be initiated prior to transmission of a BFR confirmation to the UE. In some aspects, the cell-specific BFR procedure may be initiated based on a time offset from reception of the scheduling request for the first TRP BFR.

At 912, the base station may transmit a BFR communication to initiate the cell-specific BFR. For example, 912 may be performed by BFR component 1146 of apparatus 1102. The base station may transmit the BFR communication to initiate the cell-specific BFR to the UE.

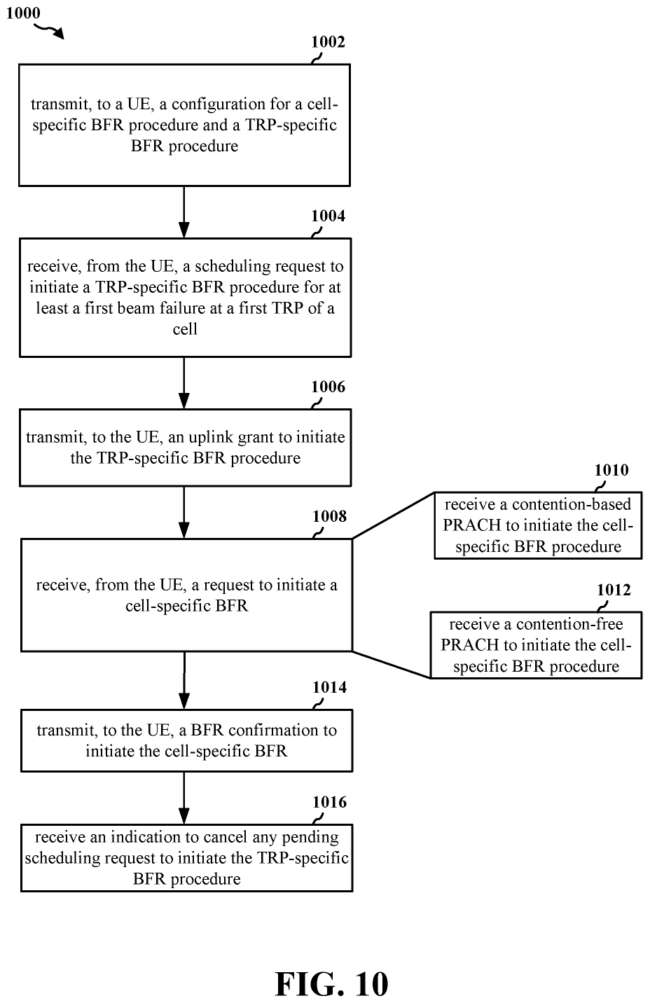

FIG. 10 is a flowchart 1000 of a method of wireless communication. The method may be performed by a base station or a component of a base station (e.g., the base station 102/180; the apparatus 1102; the baseband unit 1104, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to configure a UE to initiate a cell-specific BFR procedure upon detection of beam failures at multiple TRPs.

At 1002, the base station may transmit a configuration for BFR procedures. For example, 1002 may be performed by configuration component 1140 of apparatus 1102. The configuration for the BFR procedures may comprise a configuration for a cell-specific BFR procedure and a TRP-specific BFR procedure. The base station may transmit the configuration for the BFR procedures to a UE.

At 1004, the base station may receive a scheduling request to initiate a TRP-specific BFR procedure. For example, 1004 may be performed by SR component 1142 of apparatus 1102. The base station may receive the scheduling request to initiate the TRP-specific BFR procedure for at least a first beam failure at a first TRP of a cell. The base station may receive the scheduling request to initiate the TRP-specific BFR procedure from the UE.

At 1006, the base station may transmit an uplink grant. For example, 1006 may be performed by grant component 1144 of apparatus 1102. The base station may transmit the uplink grant to initiate the TRP-specific BFR procedure. The base station may transmit the uplink grant to the UE.

At 1008, the base station may receive a request to initiate a cell-specific BFR procedure. For example, at 1010, the base station may receive a contention-based PRACH to initiate the cell-specific BFR procedure. For example, 1010 may be performed by BFR component 1146 of apparatus 1102. In some aspects, the cell-specific BFR procedure may be initiated if the first TRP BFR and the second TRP BFR lack new beam information for a same component carrier of the cell.

As another example, at 1012, the base station may receive a contention-free PRACH to initiate the cell-specific BFR procedure. For example, 1012 may be performed by BFR component 1146 of apparatus 1102. In some aspects, the cell-specific BFR procedure may be initiated if one of the first TRP BFR or the second TRP BFR lack new beam information for a same component carrier of the cell.

The base station may receive the request to initiate a cell-specific BFR procedure based at least on the first beam failure at the first TRP or a second beam failure at a second BFR of the cell. The base station may receive the request to initiate the cell-specific BFR procedure from the UE. In some aspects, the cell-specific BFR procedure may be initiated prior to transmission of an uplink grant scheduling a transmission of the first TRP BFR. In some aspects, the cell-specific BFR procedure may be initiated prior to reception of the first TRP BFR. In some aspects, the cell-specific BFR procedure may be initiated prior to a multiplexing of the second TRP BFR with the first TRP BFR. In some aspects, the cell-specific BFR procedure may be initiated prior to transmission of a BFR confirmation to the UE. In some aspects, the cell-specific BFR procedure may be initiated based on a time offset from reception of the scheduling request for the first TRP BFR.

At 1014, the base station may transmit a BFR confirmation to initiate the cell-specific BFR. For example, 1014 may be performed by BFR component 1146 of apparatus 1102. The base station may transmit the BFR communication to initiate the cell-specific BFR to the UE.

At 1016, the base station may receive an indication to cancel any pending scheduling request to initiate the TRP-specific BFR procedure. For example, 1016 may be performed by BFR component 1146 of apparatus 1102. The indication to cancel any pending scheduling request to initiate the TRP-specific BFR procedure may terminate the TRP-specific BFR procedure.

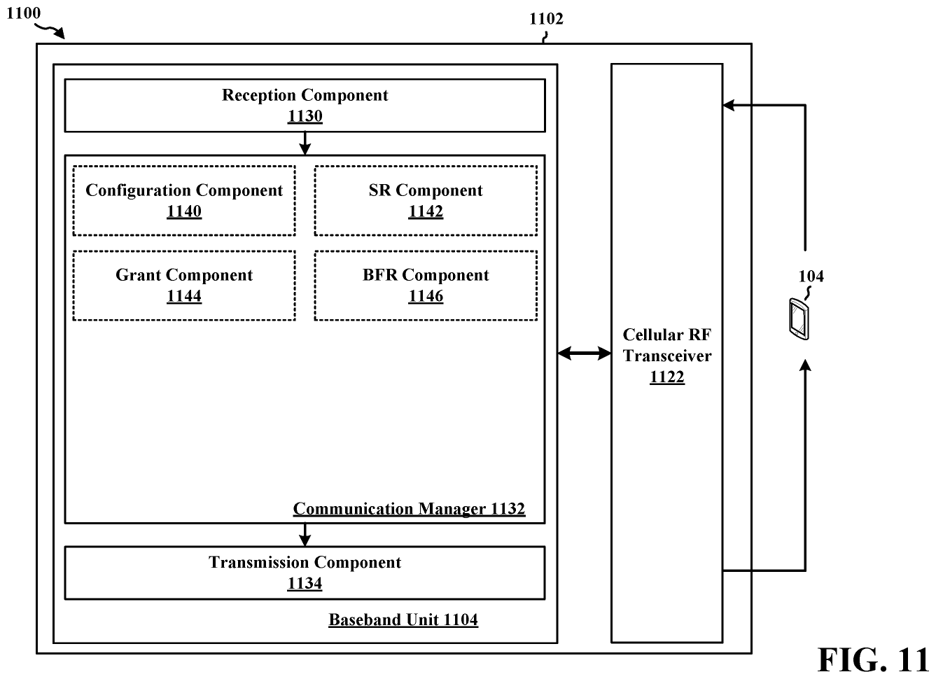

FIG. 11 is a diagram 1100 illustrating an example of a hardware implementation for an apparatus 1102. The apparatus 1102 may be a base station, a component of a base station, or may implement base station functionality. In some aspects, the apparatus 1102 may include a baseband unit 1104. The baseband unit 1104 may communicate through a cellular RF transceiver 1122 with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the base station 310 and may include the memory 376 and/or at least one of the TX processor 316, the RX processor 370, and the controller/processor 375.

The communication manager 1132 includes a configuration component 1140 that may transmit a configuration for BFR procedures, e.g., as described in connection with 902 of FIG. 9 or 1002 of FIG. 10. The communication manager 1132 further includes an SR component 1142 that may receive a scheduling request to initiate a TRP-specific BFR procedure, e.g., as described in connection with 904 of FIG. 9 or 1004 of FIG. 10. The communication manager 1132 further includes a grant component 1144 that may transmit an uplink grant, e.g., as described in connection with 1006 of FIG. 10. The communication manager 1132 further includes a BFR component 1146 that may receive a contention-based PRACH to initiate the cell-specific BFR procedure, e.g., as described in connection with 908 of FIG. 9 or 1010 of FIG. 10. The BFR component 1146 may be configured to receive a contention-free PRACH to initiate the cell-specific BFR procedure, e.g., as described in connection with 910 of FIG. 9 or 1012 of FIG. 10. The BFR component 1146 may be configured to transmit a BFR communication to initiate the cell-specific BFR, e.g., as described in connection with 912 of FIG. 9 or 1014 of FIG. 10. The BFR component 1146 may be configured to receive an indication to cancel any pending scheduling request to initiate the TRP-specific BFR procedure, e.g., as described in connection with 1016 of FIG. 10.

The apparatus may include additional components that perform each of the blocks of the algorithm in the flowcharts of FIG. 9 or 10. As such, each block in the flowcharts of FIG. 9 or 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1102 may include a variety of components configured for various functions. In one configuration, the apparatus 1102, and in particular the baseband unit 1104, includes means for transmitting, to a UE, a configuration for a cell-specific BFR procedure and a TRP-specific BFR procedure. The apparatus includes means for receiving, from the UE, a scheduling request to initiate a TRP-specific BFR procedure for at least a first beam failure at a first TRP of a cell. The apparatus includes means for receiving, from the UE, a request to initiate a cell-specific BFR based at least on the first beam failure at the first TRP or a second beam failure at a second BFR of the cell. The apparatus includes means for transmitting, to the UE, a BFR confirmation to initiate the cell-specific BFR. The apparatus further includes means for transmitting, to the UE, an uplink grant to initiate the TRP-specific BFR procedure. The apparatus further includes means for receiving a contention-based PRACH to initiate the cell-specific BFR procedure. The apparatus further includes means for receiving a contention-free PRACH to initiate the cell-specific BFR procedure. The apparatus further includes means for receiving an indication to cancel any pending scheduling request to initiate the TRP-specific BFR procedure, wherein the indication terminates the TRP-specific BFR procedure. The means may be one or more of the components of the apparatus 1102 configured to perform the functions recited by the means. As described supra, the apparatus 1102 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to receive a configuration for a cell-specific BFR procedure and a TRP-specific BFR procedure; detect a first beam failure at a first transmission reception point (TRP) of a cell; detect a second beam failure at a second TRP of the cell; and initiate the cell-specific BFR procedure based at least on the first beam failure at the first TRP or the second beam failure at the second BFR.

Aspect 2 is the apparatus of aspect 1, further including a transceiver coupled to the at least one processor.

Aspect 3 is the apparatus of any of aspects 1 and 2, further includes that the cell-specific BFR procedure is initiated if the first TRP BFR and the second TRP BFR lack new beam information for a same component carrier of the cell.

Aspect 4 is the apparatus of any of aspects 1-3, further includes that the at least one processor is further configured to transmit a contention-based PRACH to initiate the cell-specific BFR procedure.

Aspect 5 is the apparatus of any of aspects 1-4, further includes that the cell-specific BFR procedure is initiated if one of the first TRP BFR or the second TRP BFR lack new beam information for a same component carrier of the cell.

Aspect 6 is the apparatus of any of aspects 1-5, further includes that the at least one processor is further configured to transmit a contention-free PRACH to initiate the cell-specific BFR procedure.

Aspect 7 is the apparatus of any of aspects 1-6, further includes that the at least one processor is further configured to transmit at least one SR for at least one of the first TRP BFR or the second TRP BFR.

Aspect 8 is the apparatus of any of aspects 1-7, further includes that the cell-specific BFR procedure is initiated prior to receipt of an uplink grant scheduling a transmission of the first TRP BFR.

Aspect 9 is the apparatus of any of aspects 1-8, further includes that the cell-specific BFR procedure is initiated prior to transmission of the first TRP BFR.

Aspect 10 is the apparatus of any of aspects 1-9, further includes that the cell-specific BFR procedure is initiated prior to a multiplexing of the second TRP BFR with the first TRP BFR.

Aspect 11 is the apparatus of any of aspects 1-10, further includes that the cell-specific BFR procedure is initiated prior to reception of a BFR confirmation from a base station.

Aspect 12 is the apparatus of any of aspects 1-11, further includes that the cell-specific BFR procedure is initiated based on a time offset from transmission of a scheduling request for the first TRP BFR.

Aspect 13 is the apparatus of any of aspects 1-12, further includes that the at least one processor is further configured to terminate the TRP-specific BFR procedure.

Aspect 14 is the apparatus of any of aspects 1-13, further includes that to terminate the TRP-specific BFR procedure, the at least one processor is further configured to cancel any pending scheduling request transmitted for the first TRP BFR or the second TRP BFR; or stop a respective timer corresponding to the first TRP BFR or the second TRP BFR.

Aspect 15 is a method of wireless communication for implementing any of aspects 1-14.

Aspect 16 is an apparatus for wireless communication including means for implementing any of aspects 1-14.

Aspect 17 is a computer-readable medium storing computer executable code, where the code when executed by a processor causes the processor to implement any of aspects 1-14.

Aspect 18 is an apparatus for wireless communication at a base station including at least one processor coupled to a memory and configured to transmit, to a UE, a configuration for a cell-specific BFR procedure and a TRP-specific BFR procedure; receive, from the UE, a scheduling request to initiate a TRP-specific BFR procedure for at least a first beam failure at a first TRP of a cell; receive, from the UE, a request to initiate a cell-specific BFR based at least on the first beam failure at the first TRP or a second beam failure at a second BFR of the cell; and transmit, to the UE, a BFR confirmation to initiate the cell-specific BFR.

Aspect 19 is the apparatus of aspect 18, further including a transceiver coupled to the at least one processor.

Aspect 20 is the apparatus of any of aspects 18 and 19, further includes that the at least one processor is further configured to transmit, to the UE, an uplink grant to initiate the TRP-specific BFR procedure.

Aspect 21 is the apparatus of any of aspects 18-20, further includes that the cell-specific BFR procedure is initiated if the first TRP BFR and the second TRP BFR lack new beam information for a same component carrier of the cell.

Aspect 22 is the apparatus of any of aspects 18-21, further includes that the at least one processor is further configured to receive a contention-based PRACH to initiate the cell-specific BFR procedure.

Aspect 23 is the apparatus of any of aspects 18-22, further includes that the cell-specific BFR procedure is initiated if one of the first TRP BFR or the second TRP BFR lack new beam information for a same component carrier of the cell.

Aspect 24 is the apparatus of any of aspects 18-23, further includes that the at least one processor is further configured to receive a contention-free PRACH to initiate the cell-specific BFR procedure.

Aspect 25 is the apparatus of any of aspects 18-24, further includes that the cell-specific BFR procedure is initiated prior to transmission of an uplink grant scheduling a transmission of the first TRP BFR.

Aspect 26 is the apparatus of any of aspects 18-25, further includes that the cell-specific BFR procedure is initiated prior to reception of the first TRP BFR.

Aspect 27 is the apparatus of any of aspects 18-26, further includes that the cell-specific BFR procedure is initiated prior to a multiplexing of the second TRP BFR with the first TRP BFR.

Aspect 28 is the apparatus of any of aspects 18-27, further includes that the cell-specific BFR procedure is initiated prior to transmission of a BFR confirmation to the UE.

Aspect 29 is the apparatus of any of aspects 18-28, further includes that the cell-specific BFR procedure is initiated based on a time offset from reception of the scheduling request for the first TRP BFR.

Aspect 30 is the apparatus of any of aspects 18-29, further includes that the at least one processor is further configured to receive an indication to cancel any pending scheduling request to initiate the TRP-specific BFR procedure, wherein the indication terminates the TRP-specific BFR procedure.

Aspect 31 is a method of wireless communication for implementing any of aspects 18-30.

Aspect 32 is an apparatus for wireless communication including means for implementing any of aspects 18-30.

Aspect 33 is a computer-readable medium storing computer executable code, where the code when executed by a processor causes the processor to implement any of aspects 18-30.

What is claimed is:

1. An apparatus for wireless communication at a user equipment (UE), comprising:
a memory; and
at least one processor coupled to the memory and configured to:
receive a configuration for a cell-specific beam failure report (BFR) procedure and a transmission reception point (TRP)-specific BFR procedure;
detect a first beam failure at a first transmission reception point (TRP) of a cell;
detect a second beam failure at a second TRP of the cell; and
initiate the cell-specific BFR procedure based at least on the first beam failure at the first TRP or the second beam failure at the second BFR.

2. The apparatus of claim 1, further comprising a transceiver coupled to the at least one processor.

3. The apparatus of claim 1, wherein the cell-specific BFR procedure is initiated if the first TRP BFR and the second TRP BFR lack new beam information for a same component carrier of the cell.

4. The apparatus of claim 3, wherein the at least one processor is further configured to:
transmit a contention-based physical random access channel (PRACH) to initiate the cell-specific BFR procedure.

5. The apparatus of claim 1, wherein the cell-specific BFR procedure is initiated if one of the first TRP BFR or the second TRP BFR lack new beam information for a same component carrier of the cell.

6. The apparatus of claim 5, wherein the at least one processor is further configured to:
transmit a contention-free physical random access channel (PRACH) to initiate the cell-specific BFR procedure.

7. The apparatus of claim 1, wherein the at least one processor is further configured to:
transmit at least one scheduling request (SR) for at least one of the first TRP BFR or the second TRP BFR.

8. The apparatus of claim 1, wherein the cell-specific BFR procedure is initiated prior to receipt of an uplink grant scheduling a transmission of the first TRP BFR.

9. The apparatus of claim 1, wherein the cell-specific BFR procedure is initiated prior to transmission of the first TRP BFR.

10. The apparatus of claim 1, wherein the cell-specific BFR procedure is initiated prior to a multiplexing of the second TRP BFR with the first TRP BFR.

11. The apparatus of claim 1, wherein the cell-specific BFR procedure is initiated prior to reception of a BFR confirmation from a base station.

12. The apparatus of claim 1, wherein the cell-specific BFR procedure is initiated based on a time offset from transmission of a scheduling request for the first TRP BFR.

13. The apparatus of claim 1, wherein the at least one processor is further configured to:
terminate the TRP-specific BFR procedure.

14. The apparatus of claim 13, wherein to terminate the TRP-specific BFR procedure, the at least one processor is further configured to:
cancel any pending scheduling request transmitted for the first TRP BFR or the second TRP BFR; or
stop a respective timer corresponding to the first TRP BFR or the second TRP BFR.

15. A method of wireless communication at a user equipment (UE), comprising:
receiving a configuration for a cell-specific beam failure report (BFR) procedure and a transmission reception point (TRP)-specific BFR procedure;
detecting a first beam failure at a first transmission reception point (TRP) of a cell;
detecting a second beam failure at a second TRP of the cell; and
initiating the cell-specific BFR procedure based at least on the first beam failure at the first TRP or the second beam failure at the second BFR.

16. The method of claim 15, further comprising:
transmitting at least one scheduling request (SR) for at least one of the first TRP BFR or the second TRP BFR.

17. An apparatus for wireless communication at a base station, comprising:
a memory; and
at least one processor coupled to the memory and configured to:
transmit, to a user equipment (UE), a configuration for a cell-specific beam failure report (BFR) procedure and a transmission reception point (TRP)-specific BFR procedure;
receive, from the UE, a scheduling request to initiate a TRP-specific BFR procedure for at least a first beam failure at a first TRP of a cell;
receive, from the UE, a request to initiate a cell-specific BFR based at least on the first beam failure at the first TRP or a second beam failure at a second BFR of the cell; and
transmit, to the UE, a BFR confirmation to initiate the cell-specific BFR.

18. The apparatus of claim 17, further comprising a transceiver coupled to the at least one processor.

19. The apparatus of claim 17, wherein the at least one processor is further configured to:
transmit, to the UE, an uplink grant to initiate the TRP-specific BFR procedure.

20. The apparatus of claim 17, wherein the cell-specific BFR procedure is initiated if the first TRP BFR and the second TRP BFR lack new beam information for a same component carrier of the cell.

21. The apparatus of claim 20, wherein the at least one processor is further configured to:
receive a contention-based physical random access channel (PRACH) to initiate the cell-specific BFR procedure.

22. The apparatus of claim 17, wherein the cell-specific BFR procedure is initiated if one of the first TRP BFR or the second TRP BFR lack new beam information for a same component carrier of the cell.

23. The apparatus of claim 22, wherein the at least one processor is further configured to:
receive a contention-free physical random access channel (PRACH) to initiate the cell-specific BFR procedure.

24. The apparatus of claim 17, wherein the cell-specific BFR procedure is initiated prior to transmission of an uplink grant scheduling a transmission of the first TRP BFR.

25. The apparatus of claim 17, wherein the cell-specific BFR procedure is initiated prior to reception of the first TRP BFR.

26. The apparatus of claim 17, wherein the cell-specific BFR procedure is initiated prior to a multiplexing of the second TRP BFR with the first TRP BFR.

27. The apparatus of claim 17, wherein the cell-specific BFR procedure is initiated prior to transmission of a BFR confirmation to the UE.

28. The apparatus of claim 17, wherein the cell-specific BFR procedure is initiated based on a time offset from reception of the scheduling request for the first TRP BFR.

29. The apparatus of claim 17, wherein the at least one processor is further configured to:
receive an indication to cancel any pending scheduling request to initiate the TRP-specific BFR procedure, wherein the indication terminates the TRP-specific BFR procedure.

30. A method of wireless communication at a base station, comprising:
transmitting, to a user equipment (UE), a configuration for a cell-specific beam failure report (BFR) procedure and a transmission reception point (TRP)-specific BFR procedure;
receiving, from the UE, a scheduling request to initiate a TRP-specific BFR procedure for at least a first beam failure at a first TRP of a cell;
receiving, from the UE, a request to initiate a cell-specific BFR based at least on the first beam failure at the first TRP or a second beam failure at a second BFR of the cell; and
transmitting, to the UE, a BFR confirmation to initiate the cell-specific BFR.
